(19) United States
(12) Patent Application Publication
(10) Pub. No.: US 2024/0189069 A1
(43) Pub. Date: Jun. 13, 2024

(54) SYSTEM AND METHOD FOR GENERATING THREE-DIMENSIONAL DENTAL IMAGES BY PRESSURE SENSING AND DATA CONVERSION

(71) Applicant: 3D GLOBAL BIOTECH INC., New Taipei City (TW)

(72) Inventor: Keng-Liang OU, Taipei City (TW)

(73) Assignee: 3D GLOBAL BIOTECH INC., New Taipei City (TW)

(21) Appl. No.: 18/532,904

(22) Filed: Dec. 7, 2023

Related U.S. Application Data
(60) Provisional application No. 63/431,328, filed on Dec. 9, 2022.

(51) Int. Cl. A61C 7/00; G06T 7/00

(52) U.S. Cl. CPC A61C 7/002; G06T 7/0012; G06T 2207/20081; G06T 2207/30036; G06T 2210/41

(57) ABSTRACT

The invention is a system and method for generating three-dimensional dental images by pressure sensing and data conversion. The system and method include the steps of applying a dental mold body to the teeth and the gingiva of a patient, generating a sensor signal by the piezoelectric material of the dental mold body representing the pressure or force applied by the teeth and the corresponding gingiva to the piezoelectric material of the dental mold body, and/or amplifying the sensor signal by an amplifier to an amplified sensor signal, and converting the sensor signal or the amplified sensor signal by a converter into a three-dimensional dental image corresponding to the teeth configuration of the patient for a dentist to prescribe a treatment plan for the patient.

### BACKGROUND OF THE INVENTION

### 1. Field of the Invention

The present invention relates to the field of three-dimensional dental images, and more particularly to the system and method for generating three-dimensional dental images by pressure sensing and data conversion integrated with artificial intelligence (AI) technologies.

### 2. Description of the Prior Art

Misalignment of teeth in the dental arch of a patient is not just a matter of aesthetics and may also improperly affect the health of the patient. Improper teeth position may result in other dental illnesses, such as tooth decay and periodontal diseases, and misalignment of teeth may be the cause of tooth decay and render the difficulty in cleaning the teeth in between. Therefore, a proper teeth position is fundamentally important for an adequate health condition.

To correct the teeth alignment, a lot of work and attempts have been made by dentistry. One of the treatment options, orthodontic devices including braces and aligners, have been developed to align the teeth correctly by applying physical pressure to the teeth. The orthodontic devices are configured to move one or more teeth from a misaligned position to a correct(target) position.

The process of orthodontic treatment is complex. To enable the dentist to perform the complex treatment plans, firstly the dentist must access a model of the actual teeth configuration and propose one or more intermediate tooth configurations based on this model until a correct teeth alignment is achieved. Various methods for the assessment of the initial teeth configuration are known, a conventional method includes the use of a negative alginate or gypsum mold taken from the teeth of a patient. Then this negative alginate or gypsum mold is transferred into a positive model, digitized, and used for manufacturing dental braces or aligners. The conventional method is complex, costly, and time-consuming.

Recently, intraoral scanners have also been developed to facilitate the process of making dental braces or aligners by directly scanning the teeth of the patient to obtain 3D images of the initial teeth configurations. However, when scanning with an intraoral scanner, the posterior parts of the teeth tend to have blind spots which cannot be scanned thoroughly, rendering the complete teeth configuration cannot be obtained correctly. As a result, the conventional method of using negative alginate or gypsum mold is still needed for acquiring correct 3D images.

Consequently, there is a compelling need to develop a system and method that enable dentists to obtain correct 3D dental images for making an adequate treatment plan for the patients. Therefore, inventors of the present application have made a tremendous effort to make inventive research and eventually provide a system and method for generating three-dimensional dental images by pressure sensing and data conversion to facilitate and reduce the cost of the treatment.

### SUMMARY OF THE INVENTION

The prime objective of the present invention is to disclose a system and method for generating three-dimensional dental images by pressure sensing and data conversion. The system for generating three-dimensional dental images by pressure sensing and data conversion comprises a dental mold body; and/or an amplifier; and a converter. The dental mold body includes a piezoelectric material and the piezoelectric material generates a sensor signal corresponding to pressure or force applied to the piezoelectric material of the dental mold body by the teeth and the corresponding gingiva of a patient. Then the sensor signal is either transmitted to the amplifier or to the converter. When the sensor signal is transmitted to the amplifier, the amplifier amplifies the sensor signal to an amplified sensor signal and transmits the amplified sensor signal to the converter. The converter is configured to convert the sensor signal or the amplified sensor signal into a three-dimensional dental image of the teeth configuration of a patient. Then, the three-dimensional dental image of the teeth configuration of the patient can be assessed by a dentist for making an adequate plan of treatment or manufacturing an orthodontic device, such as a dental brace and aligner.

For achieving the prime objective mentioned above, the present invention provides an embodiment of a system for generating three-dimensional dental images by pressure sensing and data conversion, comprising:
a dental mold body comprising a piezoelectric material, wherein the piezoelectric material can be shaped to surround a plurality of teeth and a plurality of corresponding gingiva of a patient partially or completely and configured to generate a sensor signal, wherein the sensor signal corresponds to a pressure or force applied to the piezoelectric material of the dental mold body by the teeth and the corresponding gingiva of the patient; and/or
an amplifier electrically connected to the dental mold body and configured to receive and amplify the sensor signal to an amplified sensor signal, wherein the sensor signal is wirelessly transmitted to the amplifier; and
a converter configured to convert the sensor signal or the amplified sensor signal received respectively from the dental mold body or the amplifier into a three-dimensional dental image of the teeth configuration of the patient, wherein the sensor signal or the amplified sensor signal is wirelessly transmitted to the converter.

In one embodiment, the piezoelectric material comprises a piezoelectric polymer composite configured to flexibly conform to contours of the patient's teeth and corresponding gingiva. With the flexible conforming property, the piezoelectric material can adequately surround the teeth and the corresponding gingiva of the patient and provide a resilient interface. The sensor signal generated by the piezoelectric material may include more data or information regarding the pressure applied by the teeth and the corresponding gingiva. Therefore, a decent three-dimensional dental image can be produced based on the sensor signal for the dentist to provide a proper treatment plan for the patient.

In one embodiment, the piezoelectric material is composed of a biocompatible piezoelectric material selected from the group consisting of piezoelectric proteins, piezoelectric peptides, poly(vinylidene fluoride) (PVDF) and poly(L-lactic acid) (PLLA).

In one embodiment, the transmission of the sensor signal and the amplified sensor signal is facilitated through wireless communication protocols selected from the group consisting of WiFi, Bluetooth, WiMax, and cellular network.

In one embodiment, the converter is a remote device selected from the group consisting of a workstation, cloud server, personal computer, laptop, tablet, mobile device, wearable device. When the sensor signal or the amplified sensor signal is transmitted to the converter, the converter comprising a software application converts the sensor signal or the amplified sensor signal into the three-dimensional dental image corresponding to the teeth configuration of the patient.

In one embodiment, the system for generating three-dimensional dental images by pressure sensing and data conversion further comprises artificial intelligence algorithms and machine learning models for enhanced processing and interpretation of the three-dimensional dental image generated, wherein the machine learning models are trained on a dataset of dental images to identify a plurality of key image features and patterns, thereby improving resolution and accuracy of the three-dimensional dental image. In addition, the artificial intelligence algorithms and machine learning models are adapted to provide predictive analytics for potential dental issues.

In one embodiment, the present invention provides a method of using the aforementioned system, comprising the following steps:
S1: applying the dental mold body to a mouth of the patient, wherein the piezoelectric material of the dental mold body partially or completely surrounds or covers the teeth and the corresponding gingiva of the patient;
S2: generating the sensor signal by the piezoelectric material of the dental mold body representing the pressure applied by the teeth and the corresponding gingiva to the piezoelectric material of the dental mold body; and/or
S3: amplifying the sensor signal by the amplifier to the amplified sensor signal after the sensor signal is transmitted to the amplifier; and
S4: converting the sensor signal or the amplified sensor signal by the converter into the three-dimensional dental image corresponding to the teeth configuration of the patient after the converter receives the sensor signal or the amplified sensor;
   wherein the sensor signal can be either transmitted to the converter directly or to the amplifier for amplifying to enhance the sensor signal;
   wherein the sensor signal or the amplified sensor signal can be transmitted wirelessly or by a wire.

### BRIEF DESCRIPTION OF THE DRAWINGS

The invention, as well as a preferred mode of use and advantages thereof, will be best understood by referring to the following detailed description of an illustrative embodiment in conjunction with the accompanying drawings, wherein:

FIGS. 1A and 1B show illustrative diagrams of a dental mold body and its usage by a patient;

FIG. 2 shows a schematic illustration of a sensor signal transmitted from a dental mold body to a converter;

FIG. 3 shows a flowchart of a method for generating three-dimensional dental images by pressure sensing and data conversion according to the present invention;

FIG. 4 shows a block diagram of a system for generating three-dimensional dental images by pressure sensing and data conversion according to the present application; and

FIG. 5 shows a block diagram of an artificial intelligence module for advanced processing and analysis of the three-dimensional dental image.

### DETAILED DESCRIPTION OF THE PREFERRED EMBODIMENTS

To better illustrate the advantages of the system and method for generating three-dimensional dental images by pressure sensing and data conversion according to the present application and its contributions to the art, preferred embodiments of the present invention will be described in detail concerning the attached drawings hereafter.

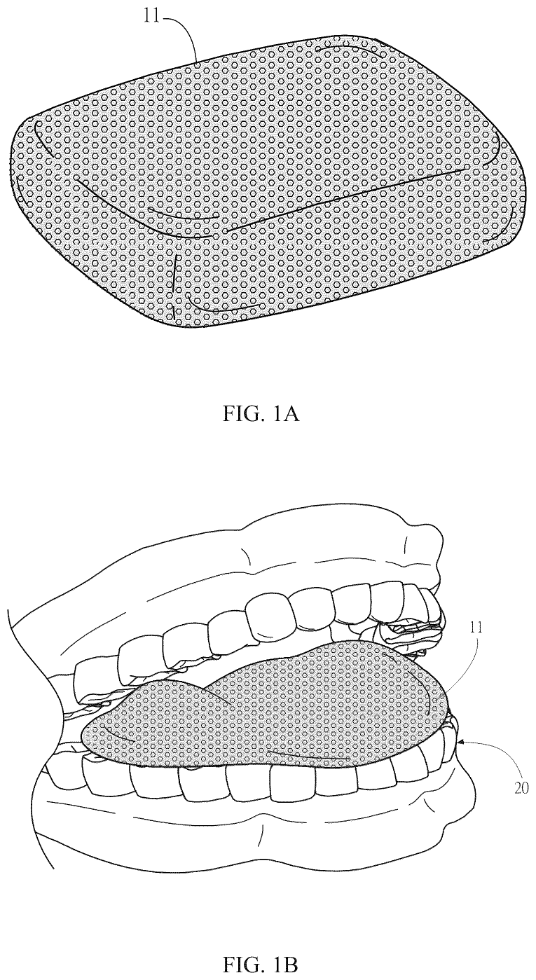

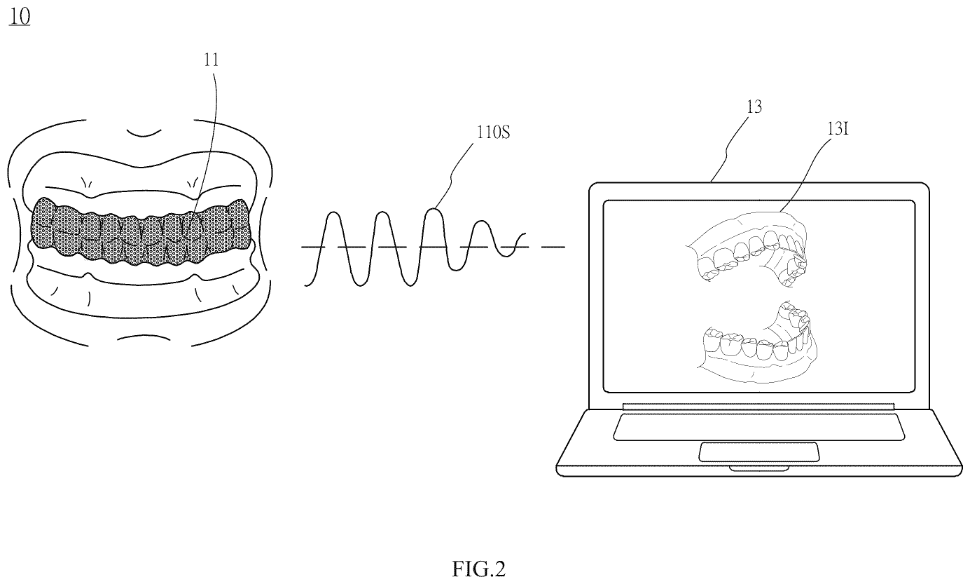

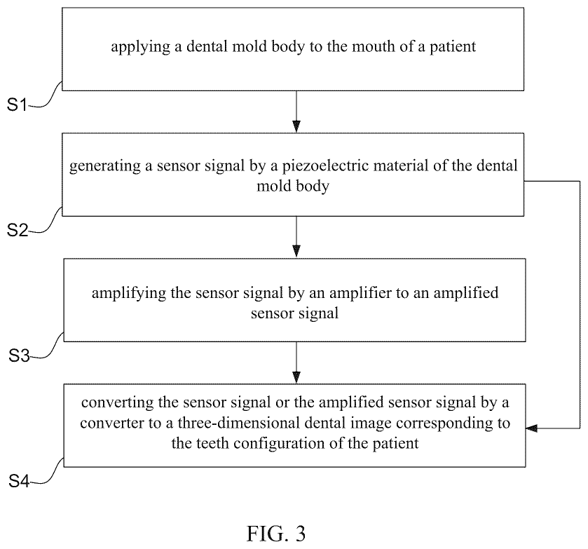

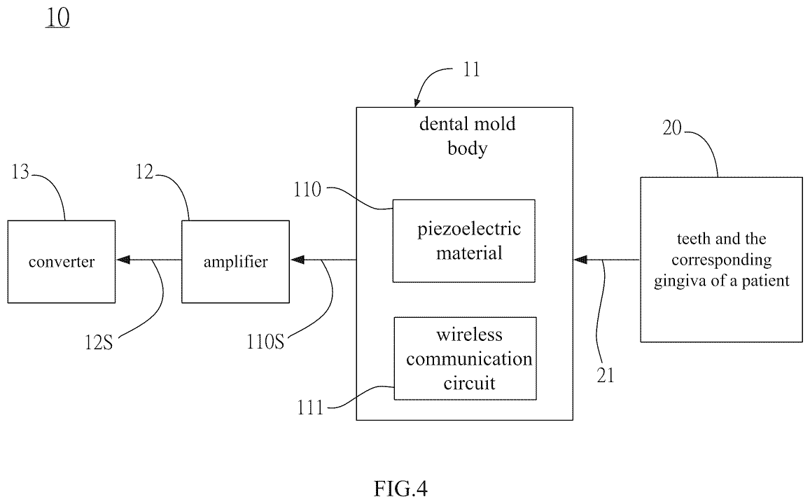

FIGS. 1A and 1B are illustrative diagrams of a dental mold body 11 and the usage of the dental mold body 11 by a patient. FIG. 2 is a schematic illustration of the system 10 for generating three-dimensional dental images 13I by pressure sensing and data conversion, in which a sensor signal 110S generated by a piezoelectric material of a dental mold body 11 is transmitted from the dental mold body 11 to a converter 13. FIG. 3 is a flowchart showing the steps for generating three-dimensional dental images 13I by pressure sensing and data conversion according to the present invention. FIG. 4 is a block diagram of system 10, comprising a dental mold body 11, an amplifier 12 and a converter 13, for generating three-dimensional dental images 13I by pressure sensing and data conversion according to the present application.

According to FIG. 1A and FIG. 1B, a dental mold body 11, comprising a piezoelectric material, is soft and flexible and can thoroughly surround or cover the teeth and corresponding gingiva 20 of a patient. The properties of being soft and flexible enable the system to generate three-dimensional dental images by pressure sensing and data conversion according to the present application to acquire a complete sensor signal regarding the pressure or force applied to the piezoelectric material of the dental mold body 11 by the teeth and the corresponding gingiva 20 of a patient. Therefore, a correct three-dimensional dental image representing the teeth configuration of the patient can be obtained based on the complete sensor signal.

In an embodiment according to FIG. 2 of the system 10 for generating three-dimensional dental images by pressure sensing and data conversion, a sensor signal 110S generated by the dental mold body 11 and representing the pressure applied to the piezoelectric material of the dental mold body 11 by the teeth and the corresponding gingiva is wirelessly transmitted to a converter 13, wherein the sensor signal 110S is converted by a specifically designed software application in the converter 13 into a three-dimensional dental image 13I corresponding to the teeth configuration of the patient.

In one embodiment, the sensor signal 110S can be transmitted to a converter 13 wirelessly through any existing wireless communication protocols, including WiFi, Bluetooth, WiMax, and cellular network. Optionally, the sensor signal 110S may also be transmitted by a wire.

In one embodiment, the piezoelectric material is specifically a piezoelectric polymer composite, engineered for its flexibility and high elasticity, allowing it to conform closely to the unique contour of the patient's teeth and corresponding gingiva 20. This material not only adequately surrounds the dental structures but also provides a precise and resilient interface for optimal pressure sensing, essential for accurate three-dimensional dental imaging.

In one embodiment, the piezoelectric material is a biocompatible piezoelectric material, including piezoelectric proteins, piezoelectric peptides, or piezoelectric biopolymers. The piezoelectric biopolymers include poly(vinylidene fluoride) (PVDF) and poly(L-lactic acid) (PLLA).

In another embodiment according to FIG. 3, a method for generating three-dimensional dental images 13I by pressure sensing and data conversion according to the present invention comprises the following steps:
S1: applying a dental mold body 11 to the mouth of a patient, wherein a piezoelectric material of the dental mold body 11 partially or completely surrounds or covers a plurality of teeth and a plurality of corresponding gingiva 20 of the patient;
S2: generating a sensor signal 110S by a piezoelectric material of the dental mold body 11 representing the pressure or force applied by the teeth and the corresponding gingiva 20 to the piezoelectric material of the dental mold body 11; and/or
S3: amplifying the sensor signal 110S by an amplifier to an amplified sensor signal after the sensor signal 110S is transmitted to the amplifier; and
S4: converting the sensor signal 110S or the amplified sensor signal by a converter 13 into a three-dimensional dental image 13I corresponding to the teeth configuration of the patient after the converter 13 receives the sensor signal 110S or the amplified sensor;
wherein the sensor signal 110S can be either transmitted to the converter 13 directly or to the amplifier for amplifying to enhance the sensor signal 110S;
wherein the sensor signal 110S or the amplified sensor signal can be transmitted wirelessly or by a wire,
wherein the sensor signal 110S and the amplified sensor signal can be transmitted wirelessly through any existing wireless communication protocols, including WiFi, Bluetooth, WiMax, and cellular network.

In one embodiment, the converter 13 can be a remote device of any computing device or system, such as a workstation, cloud server, personal computer, laptop, tablet, mobile device, wearable device, etc. When the sensor signal 110S or the amplified sensor signal is transmitted to the converter 13, a specifically designed software application therein converts the sensor signal 110S or the amplified sensor signal into a three-dimensional dental image 13I corresponding to the teeth configuration of the patient for a dentist to prescribe a treatment plan for the patient.

In a further embodiment according to the block diagram of FIG. 4, a system 10 for generating three-dimensional dental images by pressure sensing and data conversion, comprises:

a dental mold body 11 comprising a piezoelectric material 110 and a wireless communication circuit 111, wherein the piezoelectric material 110 is configured to generate a sensor signal 110S and wherein the sensor signal 110S corresponds to a pressure 21 applied to the piezoelectric material 110 of the dental mold body 11 by the teeth and the corresponding gingiva 20 of a patient;

an amplifier 12 coupled to the dental mold body 11 and configured to receive and amplify the sensor signal 110S to an amplified sensor signal 12S, wherein the sensor signal 110S is wirelessly transmitted to the amplifier 12 through the wireless communication circuit 111; and a converter 13 configured to convert the amplified sensor signal 12S received from the amplifier 12 into a three-dimensional dental image 13I of the teeth configuration of the patient.

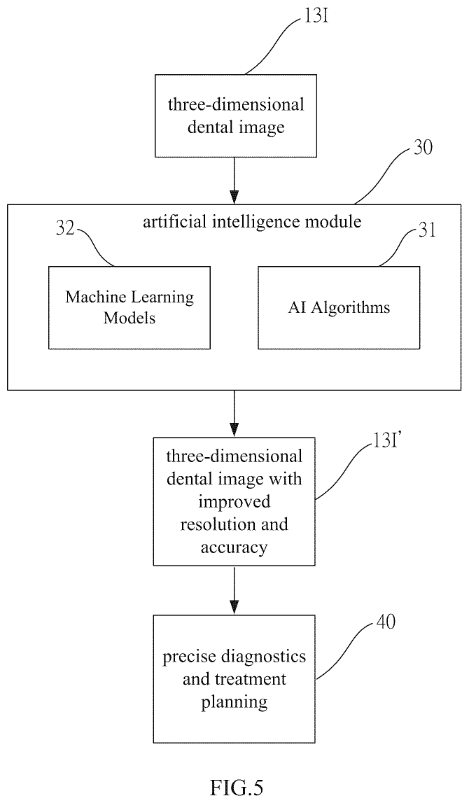

In another embodiment according to the block diagram of FIG. 5, the system 10 for generating three-dimensional dental images by pressure sensing and data conversion utilizes an artificial intelligence module 30, including artificial intelligence (AI) algorithms 31 and integrated machine learning models 32, to perform advanced processing and analysis of the three-dimensional dental image 13I obtained. The machine learning models 32 are trained on datasets of dental images to identify key image features and patterns, such as tooth morphology, alignment, periodontal structures, pathological indicators and tooth root structure. This targeted training significantly enhances the models' ability to produce the three-dimensional dental images 13I′ with improved resolution and accuracy, thereby facilitating more precise diagnostics and treatment planning 40.

The aforementioned AI algorithms 31 and machine learning models 32 also provide predictive analytics capabilities by assessing the current imaging data and the patient's medical history. They utilize intelligent pattern recognition to forecast potential dental issues such as cavities, gum disease, and microfractures, generating predictive results. Preventative measures can thus be taken based on the predictive results.

In another embodiment, the system 10 for generating three-dimensional dental images by pressure sensing and data conversion assists dentists in designing and customizing various orthodontic appliances and dental tools tailored to each patient's needs. The AI algorithms 31 analyze the three-dimensional dental image 13I to optimize the equipment specifications for improved effectiveness and comfort. This enhances the accuracy of dental tools and reduces the need for modifications.

In this embodiment, the system 10, equipped with AI algorithms 31 and machine learning models 32, conducts advanced integration and analysis of both current and historical patient data. This process enables comprehensive dental health assessments, aiding in accurate diagnostic decisions and effective treatment planning. The system's capabilities in data processing and intelligent analysis are pivotal in enhancing the overall efficiency and precision of dental care.

In this embodiment, the system 10 enhances user interaction through an intuitive user interface that integrates AI-powered features, designed to assist dentists during procedures. This interface includes capabilities for real-time image annotation, automated landmark labeling, and context-aware recommendations. These features seamlessly integrate with the system's advanced AI algorithms 31 and machine learning models 32, furthering the precision and effectiveness of dental care by providing critical information and guidance in real-time.

In this embodiment, the system's AI algorithms 31 and machine learning models 32 are rigorously trained on de-identified dental datasets, sourced from diverse patient demographics, in adherence to stringent data compliance and privacy guidelines. This training enhances the system's ability to accurately identify and analyze dental conditions across varied populations. Furthermore, systematic validation checks are conducted to ensure the accuracy and consistency of the AI's predictive outputs, thus maintaining the reliability and efficacy of the system in providing advanced dental care solutions.

In a nutshell, the above descriptions have thoroughly introduced the system and method for generating three-dimensional dental images by pressure sensing and data conversion according to the present invention. The above descriptions are made on embodiments of the present invention; however, the embodiments are not intended to limit the scope of the present invention, and all equivalent implementations or alterations within the spirit of the present invention still fall within the scope of the present invention.

What is claimed is:

1. A system for generating three-dimensional dental images by pressure sensing and data conversion, comprising
a dental mold body comprising a piezoelectric material, wherein the piezoelectric material can be shaped to surround a plurality of teeth and a plurality of corresponding gingiva of a patient partially or completely and configured to generate a sensor signal, wherein the sensor signal corresponds to a pressure applied to the piezoelectric material of the dental mold body by the teeth and the corresponding gingiva of the patient; and/or
an amplifier electrically connected to the dental mold body and configured to receive and amplify the sensor signal to an amplified sensor signal, wherein the sensor signal is wirelessly transmitted to the amplifier; and
a converter configured to convert the sensor signal or the amplified sensor signal received respectively from the dental mold body or the amplifier into a three-dimensional dental image of a teeth configuration of the patient, wherein the sensor signal or the amplified sensor signal is wirelessly transmitted to the converter.

2. The system of claim 1, wherein the piezoelectric material comprises a piezoelectric polymer composite, configured to flexibly conform to contours of the patient's teeth and corresponding gingiva.

3. The system of claim 1, wherein the piezoelectric material is composed of a biocompatible piezoelectric material selected from the group consisting of piezoelectric proteins, piezoelectric peptides, poly(vinylidene fluoride) (PVDF), and poly(L-lactic acid) (PLLA).

4. The system of claim 1, wherein the transmission of the sensor signal and the amplified sensor signal is facilitated through wireless communication protocol selected from the group consisting of WiFi, Bluetooth, WiMax, and cellular network.

5. The system of claim 1, wherein the converter is a remote device selected from the group consisting of a workstation, cloud server, personal computer, laptop, tablet, mobile device, and wearable device.

6. The system of claim 5, wherein the converter comprises a software application configured to convert the sensor signal and the amplified sensor signal into the three-dimensional dental image corresponding to the teeth configuration of the patient.

7. The system of claim 1, further comprising artificial intelligence algorithms and machine learning models for enhanced processing and interpretation of the three-dimensional dental image generated.

8. The system of claim 7, wherein the machine learning models are trained on a dataset of dental images to identify a plurality of key image features and patterns, thereby improving resolution and accuracy of the three-dimensional dental image.

9. The system of claim 7, wherein the artificial intelligence algorithms and machine learning models are adapted to provide predictive analytics for potential dental issues.

10. A method of using the system of claim 1, comprising the following steps:
S1: applying the dental mold body to a mouth of the patient, wherein the piezoelectric material of the dental mold body partially or completely surrounds or covers the teeth and the corresponding gingiva of the patient;
S2: generating the sensor signal by the piezoelectric material of the dental mold body representing the pressure applied by the teeth and the corresponding gingiva to the piezoelectric material of the dental mold body; and/or
S3: amplifying the sensor signal by the amplifier to the amplified sensor signal after the sensor signal is transmitted to the amplifier; and
S4: converting the sensor signal or the amplified sensor signal by the converter into the three-dimensional dental image corresponding to the teeth configuration of the patient after the converter receives the sensor signal or the amplified sensor;
wherein the sensor signal can be either transmitted to the converter directly or to the amplifier for amplifying to enhance the sensor signal;
wherein the sensor signal or the amplified sensor signal can be transmitted wirelessly or by a wire.
